(19) United States
(12) Patent Application Publication
(10) Pub. No.: US 2012/0242002 A1
(43) Pub. Date: Sep. 27, 2012

(54) TEMPLATE, SURFACE PROCESSING METHOD OF TEMPLATE, SURFACE PROCESSING APPARATUS OF TEMPLATE, AND PATTERN FORMATION METHOD

(75) Inventors: Masako KOBAYASHI, Kanagawa-ken (JP); Hideaki Hirabayashi, Kanagawa-ken (JP); Yoshihisa Kawamura, Kanagawa-ken (JP); Momoka Higa, Kanagawa-ken (JP)

(73) Assignee: Kabushiki Kaisha Toshiba, Tokyo (JP)

(21) Appl. No.: 13/412,019

(22) Filed: Mar. 5, 2012

(30) Foreign Application Priority Data
Mar. 25, 2011 (JP) 2011-067905

(51) Int. Cl. B29C 59/02

(52) U.S. Cl. 264/293; 425/385

(57) ABSTRACT

A template includes a transfer surface having an unevenness pattern. The template is configured to form a configuration in a surface of a resin to reflect the unevenness pattern. The resin is formed by filling a photocurable resin liquid into a recess of the unevenness pattern in a state prior to using light to cure the photocurable resin liquid and by using the light to cure the photocurable resin liquid. The template includes a base member and a surface layer. The base member includes a major surface having an unevenness. The surface layer covers the unevenness of the base member, and is used to form the unevenness pattern to reflect a configuration of the unevenness. A contact angle between the surface layer and the photocurable resin liquid in the state prior to using the light to cure the photocurable resin liquid is not more than 30 degrees.

### CROSS-REFERENCE TO RELATED APPLICATIONS

This application is based upon and claims the benefit of priority from the prior Japanese Patent Application No. 2011-067905, filed on Mar. 25, 2011; the entire contents of which are incorporated herein by reference.

### FIELD

Embodiments described herein relate generally to a template, a surface processing method of template, a surface processing apparatus of a template, and a pattern formation method.

### BACKGROUND

There exist pattern formation methods (e.g., imprint methods) for transferring an unevenness pattern provided in a template onto a resin. In such methods, equipment costs may be lower than those of conventional lithography because short-wavelength light sources, lenses, and the like are unnecessary. Such methods are expected to suppress cost increases as semiconductor devices are downscaled. An imprint method having high productivity is desirable.

### BRIEF DESCRIPTION OF THE DRAWINGS

FIG. 1A to FIG. 1E are schematic cross-sectional views in order of the processes, illustrating the configuration of a template and a pattern formation method using the template according to a first embodiment;

FIG. 2A to FIG. 2C are graphs illustrating the measurement results of the peel force;

FIG. 3A to FIG. 3C are graphs illustrating the measurement results of the work of adhesion;

FIG. 4A to FIG. 4C are graphs illustrating the measurement results of the contact angle;

FIG. 5 is a graph illustrating the relationship between the contact angle and the fill time;

FIG. 6A to FIG. 6C are schematic cross-sectional views in order of the processes, illustrating the surface processing method of the template according to the second embodiment;

FIG. 7A to FIG. 7E are schematic views in order of the processes, illustrating the surface processing method of the template according to the second embodiment;

FIG. 8A and FIG. 8B are schematic views illustrating the surface processing apparatus of the template according to the third embodiment;

FIG. 9A and FIG. 9B are schematic side views illustrating other surface processing apparatuses of the template according to the third embodiment;

FIG. 10 is a schematic side view illustrating another surface processing apparatus of the template according to the third embodiment; and

FIG. 11 is a schematic side view illustrating another surface processing apparatus of the template according to the third embodiment.

### DETAILED DESCRIPTION

In general, according to one embodiment, a template includes a transfer surface having an unevenness pattern. The template is configured to form a configuration in a surface of a resin to reflect the unevenness pattern. The resin is formed by filling a photocurable resin liquid into a recess of the unevenness pattern in a state prior to using light to cure the photocurable resin liquid and by using the light to cure the photocurable resin liquid. The template includes a base member and a surface layer. The base member includes a major surface having an unevenness. The base member is transmissive with respect to the light used to cure the photocurable resin liquid. The surface layer covers the unevenness of the base member, and is used to form the unevenness pattern to reflect a configuration of the unevenness. A contact angle between the surface layer and the photocurable resin liquid in the state prior to using the light to cure the photocurable resin liquid is not more than 30 degrees.

According to another embodiment, a surface processing method of a template is provided. The template includes a transfer surface having an unevenness pattern, and is configured to form a configuration in a surface of a resin to reflect the unevenness pattern, the resin being formed by filling a photocurable resin liquid into a recess of the unevenness pattern in a state prior to using light to cure the photocurable resin liquid and by using the light to cure the photocurable resin liquid. The surface processing method includes forming the unevenness pattern to reflect a configuration of an unevenness provided in a major surface of a base member by forming a surface layer to cover the unevenness, the base member being transmissive with respect to the light used to cure the photocurable resin liquid. A contact angle between the surface layer and the photocurable resin liquid in the state prior to using the light to cure the photocurable resin liquid is not more than 30 degrees.

According to another embodiment, a surface processing apparatus of a template is provided. The template includes a transfer surface having an unevenness pattern, and is configured to form a configuration in a surface of a resin to reflect the unevenness pattern. The resin is formed by filling a photocurable resin liquid into a recess of the unevenness pattern in a state prior to using light to cure the photocurable resin liquid and by using the light to cure the photocurable resin liquid. The apparatus includes a first processing unit and a second processing unit. The first processing unit is configured to form a hydroxide group in a major surface of a base member. An unevenness is provided in the major surface of the base member which is transmissive with respect to the light used to cure the photocurable resin liquid. The second processing unit is configured to form a surface layer to cover the unevenness of the major surface having the hydroxide group formed by the first processing unit. A contact angle between the surface layer and the photocurable resin liquid in the state prior to using the light to cure the photocurable resin liquid is not more than 30 degrees.

According to another embodiment, a pattern formation method includes filling a photocurable resin liquid into a recess of an unevenness pattern of a template, the template including a transfer surface having the unevenness pattern, the template being configured to form a configuration in a surface of a resin to reflect the unevenness pattern, the resin being formed by filling the photocurable resin liquid into the recess of the unevenness pattern in a state prior to using light to cure the photocurable resin liquid and by using the light to cure the photocurable resin liquid, the template including a base member and a surface layer, the base member including a major surface having an unevenness, the base member being transmissive with respect to the light used to cure the photocurable resin liquid, the surface layer being configured to cover the unevenness of the base member and being used to form the unevenness pattern to reflect a configuration of the unevenness, a contact angle between the surface layer and the photocurable resin liquid in the state prior to using the light to cure the photocurable resin liquid being not more than 30 degrees; forming the resin having the configuration reflecting the unevenness pattern by curing the photocurable resin liquid in the state of the photocurable resin liquid being filled into the recess by irradiating the light onto the photocurable resin liquid in the state prior to using the light to cure the photocurable resin liquid; and releasing the template and the resin from each other.

Embodiments will now be described with reference to the drawings.

The drawings are schematic or conceptual; and the relationships between the thicknesses and the widths of portions, the proportions of sizes among portions, and the like are not necessarily the same as the actual values thereof. Further, the dimensions and the proportions may be illustrated differently among the drawings, even for identical portions.

In the specification and the drawings of the application, components similar to those described in regard to a drawing thereinabove are marked with like reference numerals, and a detailed description is omitted as appropriate.

### First Embodiment

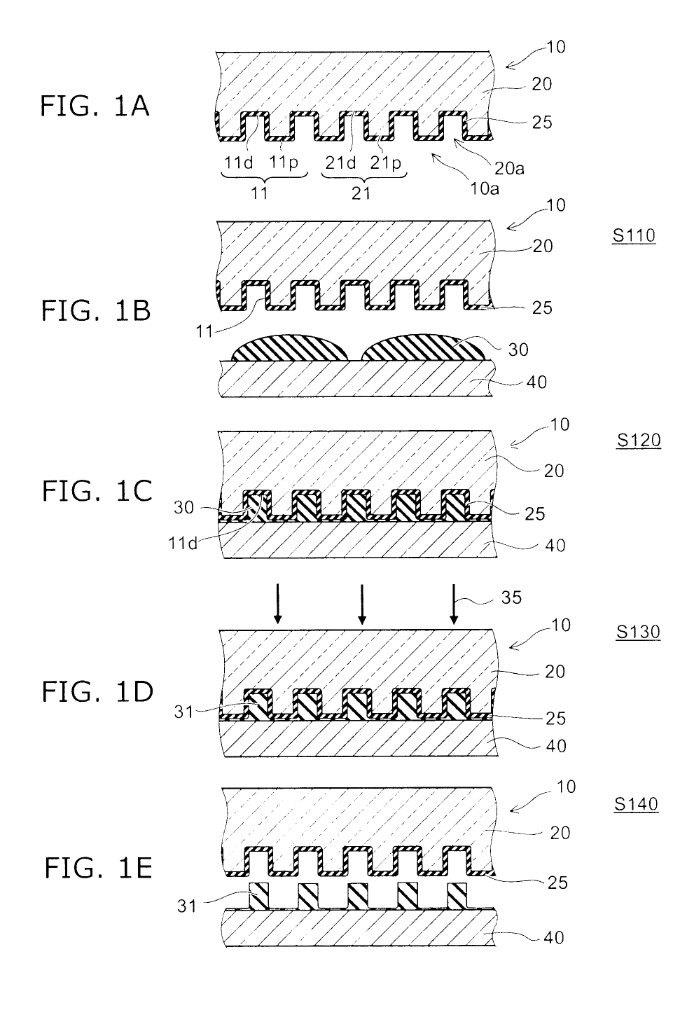

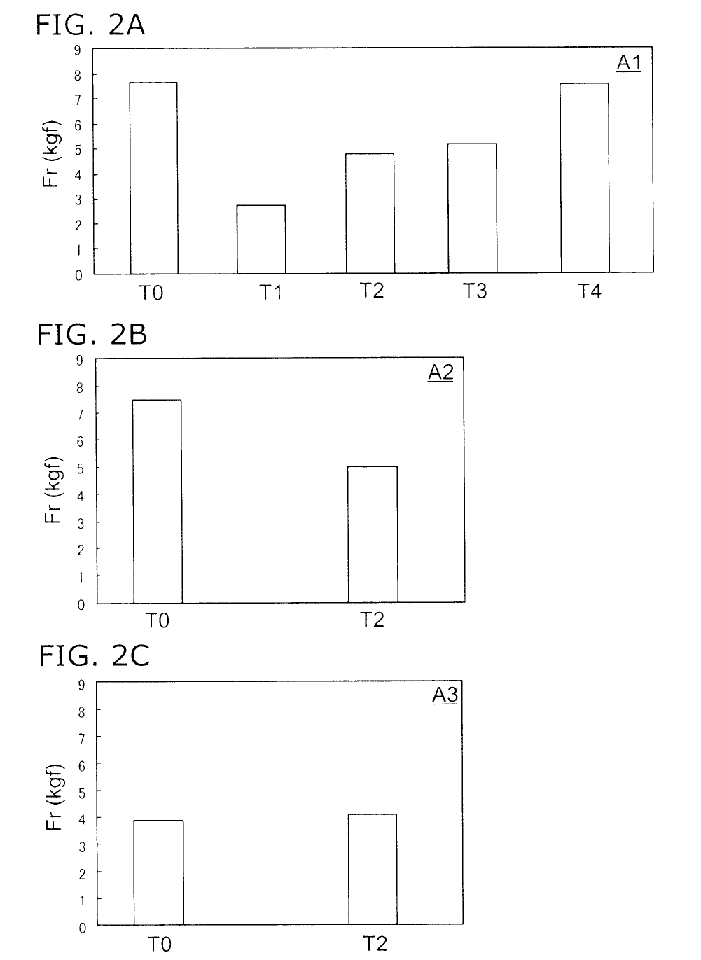

FIG. 1A to FIG. 1E are schematic cross-sectional views in order of the processes, illustrating the configuration of a template and a pattern formation method using the template according to a first embodiment.

As illustrated in FIG. 1A, the template 10 according to this embodiment includes a base member 20 and a surface layer 25.

The template 10 includes a transfer surface 10a. An unevenness pattern 11 is provided in the transfer surface 10a. The unevenness pattern 11 includes, for example, a recess 11d and a protrusion 11p. For example, the recess 11d is multiply provided; and the protrusion 11p is multiply provided. For example, a continuous recess 11d and multiple protrusions 11p may be provided. For example, a continuous protrusion 11p and multiple recesses 11d may be provided.

The unevenness pattern 11 has, for example, a trench configuration and/or a hole configuration. The depth of the recess 11d (the height of the protrusion 11p) is, for example, not less than about 20 nanometers (nm) and not more than about 200 nm. The width of the recess 11d is, for example, not less than about 10 nm and not more than about 100 nm. The width of the protrusion 11p is, for example, not less than about 10 nm and not more than about 100 nm. However, the embodiment is not limited thereto. The depth of the recess 11d, the width of the recess 11d, and the width of the protrusion 11p are arbitrary.

As described below, the template 10 is a template configured to form a configuration in a surface of a resin to reflect the unevenness pattern 11 of the template 10, where the resin is formed by filling a photocurable resin liquid 30 into the recess 11d of the unevenness pattern 11 of the template 10 and by using light to cure the photocurable resin liquid 30. Here, the photocurable resin liquid 30 is a resin liquid in the state prior to using the light to cure the photocurable resin liquid 30.

The photocurable resin liquid 30 may include, for example, a resin liquid such as an acrylic resin, an epoxy resin, and the like. The photocurable resin liquid 30 is cured using, for example, ultraviolet light.

The base member 20 is transmissive with respect to the light used to cure the photocurable resin liquid 30. The base member 20 includes, for example, quartz. The base member 20 includes a major surface 20a in which an unevenness 21 is provided. The unevenness 21 includes a base member recess 21d and a base member protrusion 21p. The configuration of the unevenness 21 reflects the configuration of the unevenness pattern 11.

The surface layer 25 covers the unevenness 21 of the base member 20. The surface layer 25 is used to form the unevenness pattern 11 that reflects the configuration of the unevenness 21. In other words, the surface of the surface layer 25 becomes the unevenness pattern 11 recited above.

The configuration of the unevenness 21 of the major surface 20a of the base member 20 differs from the configuration of the unevenness pattern 11 of the transfer surface 10a of the template 10 in that the configuration of the unevenness 21 of the major surface 20a of the base member 20 is narrower by a width corresponding to twice the thickness of the surface layer 25.

The thickness of the surface layer 25 is shallower than the depth of the unevenness 21. Thereby, the unevenness pattern 11 that reflects the configuration of the unevenness 21 can be formed. The thickness of the surface layer 25 is, for example, not less than about 1 nm and not more than about 5 nm. However, the embodiment is not limited thereto. The thickness of the surface layer 25 is arbitrary if the unevenness pattern 11 that reflects the configuration of the unevenness 21 can be formed.

The contact angle between the surface layer 25 and the photocurable resin liquid 30 in the state prior to using the light to cure the photocurable resin liquid 30 is not more than 30 degrees.

Thereby, a template can be provided to realize a pattern formation method having high productivity. Such characteristics are described below.

One example of a pattern formation method using a template will now be described.

As illustrated in FIG. 1B, the photocurable resin liquid 30 is disposed on the major surface of a processing substrate 40 on which the pattern is to be formed (step S110). Here, the photocurable resin liquid 30 is a resin liquid in a state prior to using light to cure the photocurable resin liquid 30. For example, inkjet and the like are used to dispose the photocurable resin liquid 30. However, the embodiment is not limited thereto. Any method may be used to dispose the photocurable resin liquid 30.

Then, the transfer surface 10a of the template 10 is caused to oppose the photocurable resin liquid 30 which is on the processing substrate 40.

As illustrated in FIG. 1C, the photocurable resin liquid 30 is filled into the recess 11d of the unevenness pattern 11 of the template (step S120).

As illustrated in FIG. 1D, the photocurable resin liquid 30 is cured by irradiating light 35 onto the photocurable resin liquid 30 in the state of the photocurable resin liquid 30 being filled into the recess 11d (step S130). Thereby, a resin 31 having a pattern configuration that reflects the unevenness pattern 11 is formed. The resin 31 is formed by curing the photocurable resin liquid 30 using the light 35.

As illustrated in FIG. 1E, the template 10 and the resin 31 are released from each other (step S140). Thereby, the resin 31 having the configuration that reflects the unevenness pattern 11 of the template 10 is formed on the major surface of the processing substrate 40. In other words, the unevenness pattern 11 is transferred onto the resin 31. The processing substrate 40 is patterned by, for example, using the resin 31 as the mask.

In the process illustrated in FIG. 1C, there are cases where the photocurable resin liquid 30 exists between the protrusion 11p of the template 10 and the processing substrate 40. In such a case, a residual film is formed on the processing substrate 40 opposing the protrusion 11p. This residual film may be removed using a method such as dry etching and the like if necessary.

In the case where the adhesion between the template 10 and the resin 31 cured using the light 35 is high in the pattern formation method recited above, a portion of the resin 31 may remain in the recess 11d of the unevenness pattern 11 in step S140 recited above. In other words, the layer of the resin 31 is destroyed; and a portion of the resin 31 remains inside the recess 11d. The resin 31 remaining in the recess 11d causes defects to occur in the next transfer process. Therefore, there are configurations in which a template release layer is provided to reduce the adhesion between the template 10 and the cured resin 31.

Such a template release layer is provided, for example, to cover the unevenness 21 of the base member 20. For example, a fluoric surface processing layer and the like are used as the template release layer. Thereby, the adhesion between the template 10 and the cured resin 31 is reduced; and the occurrence of portions of the resin 31 that remain in the recess 11d of the unevenness pattern 11 is suppressed.

However, according to experiments of the inventor, it was ascertained that the time necessary to fill the resin liquid into the recess 11d of the template 10 is extremely long in the case where such a template release layer is provided on the template 10, which is a major factor that obstructs increasing the productivity of pattern formation methods using imprinting.

The inventor performed the following experiments. A base member 20 of quartz glass was used in the experiments.

The unevenness 21 was provided in the base member 20. The depth of the unevenness 21 (the depth of the base member recess 21d) was 60 nm. The width of the base member recess 21d (the width of the bottom portion) was 24 nm; and the width of the base member protrusion 21p was 24 nm. The unevenness 21 had a trench configuration.

The time (the fill time) for a photocurable resin liquid (a first resin liquid A1) including an acrylic monomer to fill into the recess of the unevenness 21 (the base member recess 21d) when such a base member 20 was used as-is as the template was measured to be about 20 seconds.

On the other hand, a template release layer was formed on the surface of the unevenness 21 of the base member 20 using a fluoric silane coupling agent (a first processing agent). The fill time was measured to be not less than 300 seconds. Thus, the fill time is markedly longer in the case where a template release layer (e.g., a layer of a fluoric silane coupling agent) is provided.

In a configuration in which a template release layer such as that recited above is provided, the surface energy of the template release layer is set to be small by focusing on the releasability of the cured resin 31. As a result, the template release layer repels the resin liquid; and the resin liquid is obstructed from entering the recess 11d of the template 10 covered with the template release layer. In other words, the template release layer reduces the fillability. In other words, in a conventional template release layer, only the releasability is improved; and no concern is given to the fillability.

The inventor discovered that the time necessary to fill the resin liquid into the recess 11d of the template 10 greatly affects the productivity of the entire pattern formation. A new configuration having high fillability is desired to shorten the time necessary to fill the resin liquid into the recess 11d while maintaining a high releasability between the template 10 and the cured resin 31. The inventor discovered such new problems and constructed the configuration according to the embodiment to solve such problems. In other words, in the embodiment, the characteristics relating to the wettability between the surface layer 25 and the photocurable resin liquid 30 in the state prior to using the light to cure the photocurable resin liquid 30 are appropriately controlled. Thereby, a high fillability is obtained while obtaining a high releasability between the surface layer 25 of the template 10 and the photocurable resin liquid 30 in the state prior to using the light to cure the photocurable resin liquid 30; and a high releasability also can be obtained between the surface layer 25 of the template 10 and the resin 31 of the photocurable resin liquid 30 cured using the light.

Experiments relating to the releasability and the fillability implemented by the inventor will now be described.

Multiple types of surface processing agents (first to fourth processing agents) and multiple types of photocurable resin liquids 30 (first to third resin liquids) were used in the experiments.

The first processing agent was a fluoric processing agent. The first processing agent was used to form a first surface processing layer T1 including fluorine. The first processing agent is the surface processing agent used in the experiment recited above in which the fill time was measured.

The second processing agent was hexamethyldisilazane (HMDS). In other words, the second processing agent was used to form a second surface processing layer T2 including a methyl group.

The third processing agent was methyltrimethoxysilane. In other words, the third processing agent was a silane coupling agent including a methyl group as a functional group and was used to form a third surface processing layer T3 including a methyl group.

The fourth processing agent was phenyltrimethoxysilane. In other words, the fourth processing agent was a silane coupling agent including a phenyl group as a functional group and was used to form a fourth surface processing layer T4 including a phenyl group.

Substrates of quartz glass were processed using these processing agents to form the first to fourth surface processing layers T1 to T4 on the substrates. A sample on which the surface processing was not performed (an unprocessed sample T0) also was constructed.

The surface processing layers were formed on the substrates for the first processing agent (the fluoric silane coupling agent), the third processing agent (the methyl group silane coupling agent), and the fourth processing agent (the phenyl group silane coupling agent) by processing in the liquid phase (wet processing). For the silane coupling agents, the surface processing layers were formed by hydrolysis and a condensation reaction of the silane coupling agent.

For the second processing agent (HMDS), the surface processing layer was formed on the substrate by processing in the vapor phase (dry processing). Vapor phase processing has the advantage of, for example, fewer particles and aggregates.

For the second processing agent, a cleaned substrate was exposed to a vapor of the second processing agent produced by heating at 50° C. and by subsequently heating at 110° C. for 10 minutes. The excess second processing agent adhered to the surface was removed by this heating. Thereby, the second surface processing layer T2 was formed using the second processing agent.

On the other hand, a processing solution was prepared by diluting the third processing agent of the silane coupling agent in an acetic acid aqueous solution. The concentration of the acetic acid was 0.1 wt %. The concentration of the third processing agent was 0.5 wt %. A cleaned substrate was immersed in this processing solution; the substrate was subsequently extracted; and heating was performed at 110° C. for 10 minutes. Thereby, a condensation reaction was promoted. Thereby, the third surface processing layer T3 was formed using the third processing agent. Similarly, the fourth surface processing layer T4 was formed using the fourth processing agent. Similarly, the first surface processing layer T1 was formed by processing the substrate using the first processing agent.

On the other hand, the first to third resin liquids A1 to A3 were used as the photocurable resin liquid 30. The first resin liquid A1 was a photocurable resin liquid including an acrylic monomer and was also used in the experiment recited above in which the fill time was measured. A second resin liquid A2 was a resin liquid in which a fluorine compound was added to the first resin liquid A1. It is considered that the fluorine compound improves the releasability. The third resin liquid A3 was an acrylic photocurable resin liquid having a component different from that of the first resin liquid A1 to which a fluorosurfactant was added.

The releasability and the fillability were evaluated for these surface processing layers and resin liquids.

The peel force was measured as an index relating to the releasability between the surface processing layer and the resin formed by curing the resin liquid. In this experiment, the substrate of quartz glass was processed using the surface processing agent. The resin liquid was disposed between two substrates processed with the same type of surface processing agent and by curing the resin liquid. Specifically, 5 micro liters of the resin liquid was dropped on a substrate; a substrate was placed on the resin liquid; the substrates were pressed together; and the resin was formed by curing the resin liquid by irradiating ultraviolet light in this state. Then, a peel force Fr when the two substrates were peeled from each other was measured. The releasability is good when the peel force Fr is small.

A work of adhesion Wa was measured between the multiple types of surface processing layers and the multiple types of resins. In other words, the contact angles of water, ethylene glycol, and formaldehyde were measured for the surface processing layers and the resins. Then, the surface energy was determined from the measurement results of the contact angles for each of the surface processing layers and each of the resins using a Kaelble-Uy model. Then, the work of adhesion Wa was determined from the surface energy that was determined for the combinations of the surface processing layers and the resins.

A contact angle θ which is considered to have a relationship with the fillability was measured. In other words, the surface processing layers recited above were formed on the substrates of quartz glass; and the contact angle θ was measured for the combinations of the surface processing layers and the resin liquids recited above.

The peel force Fr, the work of adhesion Wa, and the contact angle θ also were evaluated for the unprocessed sample T0 (the substrate of quartz glass) for which the surface processing layer was not formed.

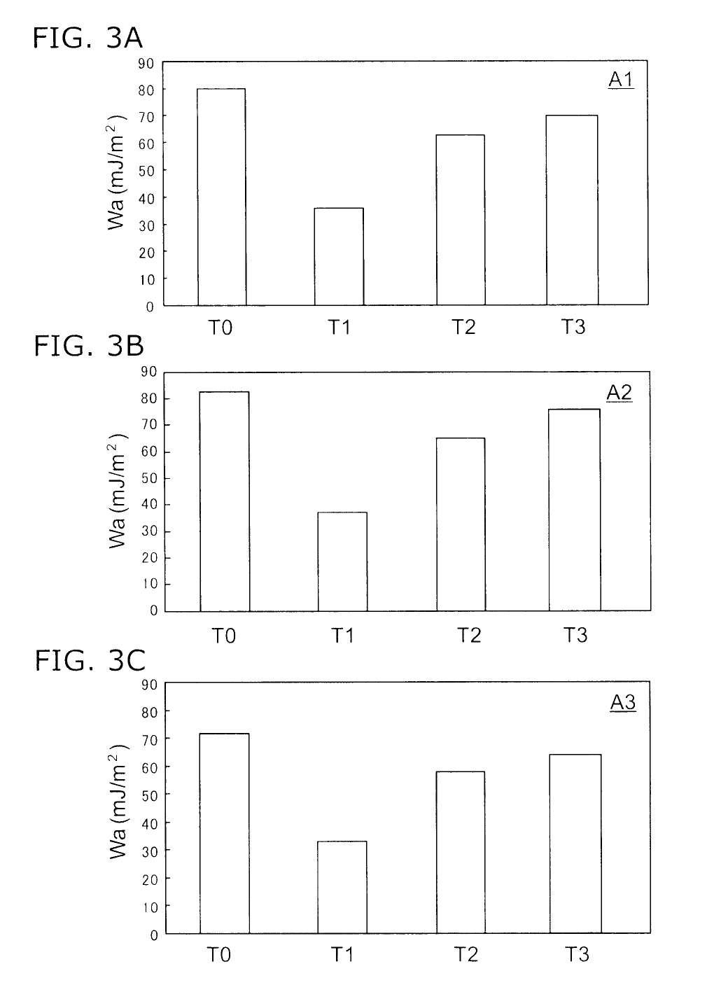

FIG. 2A to FIG. 2C are graphs illustrating the measurement results of the peel force.

FIG. 2A, FIG. 2B, and FIG. 2C illustrate the measurement results of the peel force Fr for the first resin liquid A1, the second resin liquid A2, and the third resin liquid A3, respectively.

FIG. 2A illustrates the peel force Fr for the resin formed using the first resin liquid A1 and each of the surface processing layers T0 to T4. As illustrated in FIG. 2A, the peel force Fr of the unprocessed sample T0 was about 7.7 kgf. Conversely, the peel force Fr of the fluoric first surface processing layer T1 was about 3.3 kgf and was extremely small. The peel forces Fr of the second surface processing layer T2 and the third surface processing layer T3 of the methyl group were about 5.0 kgf to 5.5 kgf. Thus, the peel forces Fr of the second surface processing layer T2 and the third surface processing layer T3 were about 20% to 40% lower than that of the unprocessed sample T0. The peel force Fr of the fourth surface processing layer T4 of the benzene group was similar to the peel force Fr of the unprocessed sample T0. It is considered that the releasability of the fourth surface processing layer T4 did not improve.

In the second resin liquid A2 and the third resin liquid A3 as well as illustrated in FIG. 2B and FIG. 2C, the peel force Fr of the second surface processing layer T2 of the methyl group was smaller than that of the unprocessed sample T0.

Thus, it is considered that the releasability improved for the second surface processing layer T2 and the third surface processing layer T3 of the methyl group.

FIG. 3A to FIG. 3C are graphs illustrating the measurement results of the work of adhesion.

FIG. 3A, FIG. 3B, and FIG. 3C illustrate the measurement results of the work of adhesion Wa for the resins of the first resin liquid A1, the second resin liquid A2, and the third resin liquid A3, respectively.

As illustrated in FIG. 3A, the work of adhesion Wa between the resin of the first resin liquid Al and the unprocessed sample TO was about 80 millijoules/square meters (mJ/m²). Conversely, the work of adhesion Wa between the resin of the first resin liquid A1 and the fluoric first surface processing layer T1 was about 35 mJ/m² and was extremely small. The work of adhesion Wa of the second surface processing layer T2 and the third surface processing layer T3 of the methyl group were not less than about 60 mJ/m² and not more than about 70 mJ/m². Thus, the work of adhesion Wa of the second surface processing layer T2 and the third surface processing layer T3 were lower than that of the unprocessed sample T0.

In the second resin liquid A2 and the third resin liquid A3 as well as illustrated in FIG. 3B and FIG. 3C, the work of adhesion Wa of the fluoric first surface processing layer T1 was markedly small. The work of adhesion Wa for the second surface processing layer T2 and the third surface processing layer T3 of the methyl group were slightly smaller than that of the unprocessed sample T0.

Thus, it is considered that the releasability improved for the second surface processing layer T2 and the third surface processing layer T3 of the methyl group.

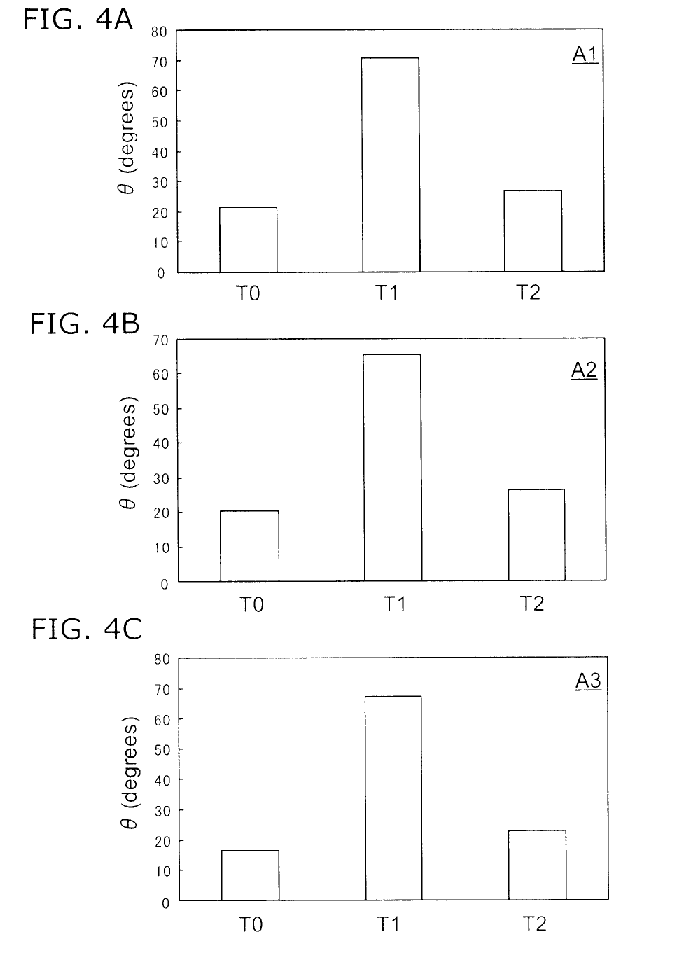

FIG. 4A to FIG. 4C are graphs illustrating the measurement results of the contact angle.

FIG. 4A, FIG. 4B, and FIG. 4C illustrate the measurement results of the contact angles θ of the first resin liquid A1, the second resin liquid A2, and the third resin liquid A3, respectively.

As illustrated in FIG. 4A, the contact angle θ between the first resin liquid A1 and the unprocessed sample T0 was about 20 degrees. Conversely, the contact angle θ between the first resin liquid A1 and the fluoric first surface processing layer T1 was 60 degrees to 70 degrees and was extremely large. The contact angle θ between the first resin liquid A1 and the second surface processing layer T2 of the methyl group was about 27 degrees.

For the second resin liquid A2 and the third resin liquid A3 as well as illustrated in FIG. 3B and FIG. 3C, the contact angle θ of the fluoric first surface processing layer T1 was markedly large. The contact angle θ of the second surface processing layer T2 of the methyl group was 23 degrees to 26 degrees. In such a case as well, the contact angle θ of the second surface processing layer T2 was slightly larger than that of the unprocessed sample T0.

As described above, the fill time of the first resin liquid A1 was about 20 seconds for the combination of the unprocessed sample T0 and the first resin liquid A1. On the other hand, the fill time of the template on which the fluoric first surface processing layer T1 (which is the template release layer) was provided was about 300 seconds. It is considered that such a difference in fill times was caused by the difference in the contact angles θ with the first resin liquid A1.

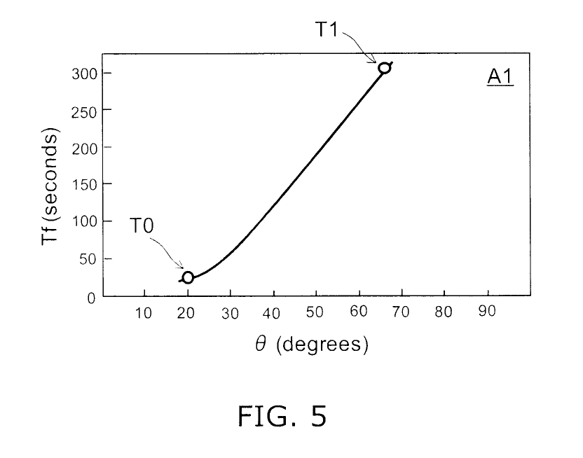

FIG. 5 is a graph illustrating the relationship between the contact angle and the fill time.

The horizontal axis of this graph is the contact angle θ. The vertical axis is a fill time Tf.

As illustrated in FIG. 5, the fill time Tf was about 20 seconds in the case where the contact angle θ was about 20 degrees. The fill time Tf was not less than 300 seconds in the case where the contact angle θ was 60 degrees to 70 degrees. From this graph, the fill time Tf was about 20 seconds to 30 seconds for the second surface processing layer T2 for which the contact angle θ was 23 degrees to 27 degrees.

Thus, for the second surface processing layer T2 including the methyl group, the peel force Fr and the work of adhesion Wa were lower than those of the unprocessed sample T0, and the releasability was improved while maintaining the fillability and maintaining substantially the same contact angle θ as that of the unprocessed sample T0.

Thus, for the template 10 according to the embodiment, the contact angle θ between the surface layer 25 (the surface processing layer) and the photocurable resin liquid 30 is set to be not more than 30 degrees. From FIG. 5, a fill time Tf not more than 50 seconds is obtained by setting the contact angle θ to be not more than 30 degrees. In other words, the fill time of the embodiment is substantially the same as that of the unprocessed sample T0 and is markedly shorter than that of the fluoric surface processing layer. Further, the releasability is improved by the surface layer 25 having such characteristics.

Thus, according to the template 10 according to the embodiment, a template can be provided to realize a pattern formation method having high productivity. Further, a pattern formation method having high productivity can be provided.

When filling the photocurable resin liquid 30 into the recess 11d of the template 10, there are cases where the processing substrate 40 and the template 10 are pressed together. The pattern of the unevenness pattern 11 (the fine pattern) of the template 10 is destroyed in the case where the pressurizing force is excessively large. The pressurizing force can be reduced for the template 10 according to the embodiment because the fillability is good. Therefore, in the embodiment, the pattern destruction of the unevenness pattern 11 of the template 10 is suppressed.

Because the fillability is good in the embodiment, it is possible to sufficiently fill the photocurable resin liquid 30 into the recess 11d of the template 10 even in the case where the amount of the photocurable resin liquid 30 used when filling is small. In other words, the photocurable resin liquid 30 can be filled into the recess 11d with less uneven filling, even in the case of a small amount of the photocurable resin liquid 30.

As described in regard to FIG. 3A to FIG. 3C, the work of adhesion Wa was less than 80 mJ/m² for the second surface processing layer T2 and the third surface processing layer T3. Specifically, for example, the work of adhesion Wa was not less than 60 mJ/m² and not more than 70 mJ/m². Thereby, the work of adhesion Wa was lower than that of the unprocessed sample T0 (the work of adhesion Wa was about 80 mJ/m²); and the peelability was improved. Thus, in the embodiment, it is desirable for the work of adhesion Wa of the surface layer 25 to the resin 31 (the resin formed by curing the photocurable resin liquid 30) to be less than 80 mJ/m².

As recited above, it is favorable for a surface processing agent including a methyl group to be used as a functional group to set the contact angle θ between the surface layer 25 (the surface processing layer) and the photocurable resin liquid 30 to be not more than 30 degrees.

In the template 10 according to the embodiment, the surface layer 25 may include a layer formed by bonding a compound represented by Rₙ—Si—X₄₋ₙ to the base member 20 by a condensation reaction of the compound (where n is an integer not less than 1 and not more than 3, X is a functional group, and R is an organic functional group). In this compound represented by Rₙ—Si—X₄₋ₙ, X is, for example, an alkoxy group, an acetoxy group, or a halogen atom. In other words, a surface layer 25 formed using a silane coupling agent may be used.

In the compound recited above, R may be an alkyl group represented by CH₃(CH₂)ₖ (where k is an integer not less than 0). In particular, it is desirable for R to be a methyl group.

Thereby, in particular, it is easier to improve the releasability while maintaining the fillability.

In the template 10 according to the embodiment, the surface layer 25 may include a layer formed by bonding a compound represented by R₃—Si—NH.Si.R′₃ to the base member 20 (where R′ is an organic functional group and R is an organic functional group). For example, in this compound, R′ is an alkyl group. R is an alkyl group represented by CH₃(CH₂)ₖ (where k is an integer not less than 0). In particular, R is a methyl group.

In the template 10 according to the embodiment, the surface layer 25 may include a layer formed by bonding a compound represented by R₃—Si—NR′₂ to the base member 20 (where R′ is an organic functional group and R is an organic functional group). For example, in this compound, R′ is an alkyl group. R is an alkyl group represented by CH₃(CH₂)ₖ (where k is an integer not less than 0). In particular, R may be a methyl group.

In other words, the surface layer 25 may be formed of, for example, HMDS (the second processing agent recited above). For example, fewer particles and aggregates occur when performing, for example, processing in the vapor phase using HMDS. Other than the HMDS recited above, TMSDMA ((trimethylsilyl)dimethylamine) and the like may be used in the vapor phase as the surface processing agent to form the surface layer 25 including the methyl group.

### Second Embodiment

This embodiment is a surface processing method of the template 10 that has the transfer surface 10a in which the unevenness pattern 11 is provided to form a configuration that reflects the unevenness pattern 11 in a surface of the resin 31 formed by filling the photocurable resin liquid 30 into the recess 11d of the unevenness pattern 11 and by curing the photocurable resin liquid 30.

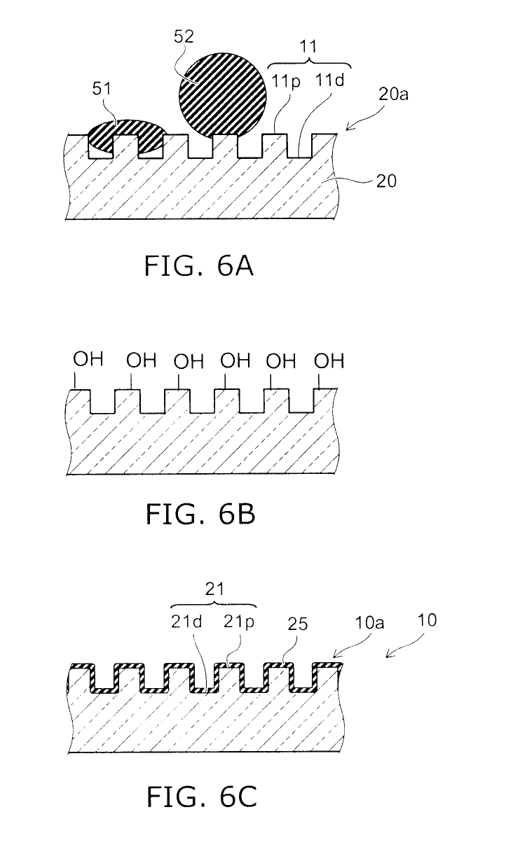

FIG. 6A to FIG. 6C are schematic cross-sectional views in order of the processes, illustrating the surface processing method of the template according to the second embodiment.

In this surface processing method as illustrated in FIG. 6A, the base member 20 that is used has the major surface 20a in which the unevenness 21 is provided and is transmissive with respect to the light (e.g., the ultraviolet light) used to cure the photocurable resin liquid 30. There are cases where, for example, an organic contaminant 51, a particle 52, and the like are adhered to the major surface 20a of the base member 20. Cleaning to remove the organic contaminant 51, the particle 52, etc., is performed if necessary.

Thereby, as illustrated in FIG. 6B, for example, a hydroxide group is formed in the surface of the base member 20. Then, as illustrated in FIG. 6C, the surface layer 25 that has a contact angle θ with the photocurable resin liquid 30 of not more than 30 degrees is formed to cover the unevenness 21 of the base member 20. Thereby, the unevenness pattern 11 that reflects the configuration of the unevenness 21 is formed. The surface layer 25 is formed using, for example, a silane coupling agent.

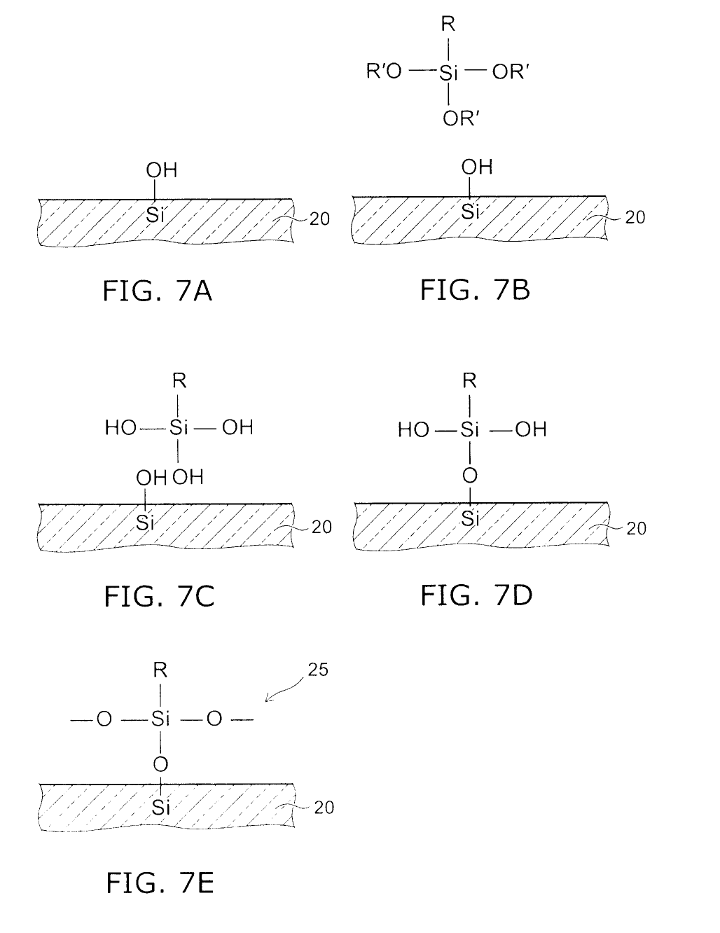

FIG. 7A to FIG. 7E are schematic views in order of the processes, illustrating the surface processing method of the template according to the second embodiment.

These drawings illustrate the method for forming the surface layer 25 using a silane coupling agent.

As illustrated in FIG. 7A, a hydroxide group is formed in the surface of the base member 20. In this example, the hydroxide group is a silanol group. For example, the hydroxide group can be formed by at least one selected from ultraviolet irradiation, plasma processing, and chemical liquid processing of the surface of the base member 20.

As illustrated in FIG. 7B and FIG. 7C, the silane coupling agent undergoes hydrolysis. Then, as illustrated in FIG. 7D, a portion of the silane coupling agent bonds to the base member 20 by a condensation reaction. Further, as illustrated in FIG. 7E, the silane coupling agent polymerizes with itself. Thereby, the surface layer 25 is formed. The surface layer 25 is in the state of the organic functional group R being exposed at the surface. The contact angle θ can be set to be not more than 30 degrees by setting the organic functional group R appropriately.

It is desirable for the formation of the surface layer 25 to include vapor deposition of the surface layer 25. The surface layer 25 can be formed in the vapor phase by using, for example, HMDS or TMSDMA. Thereby, few particles and aggregates occur; and it is easier to form a uniform surface layer 25.

### Third Embodiment

The surface processing apparatus of a template according to this embodiment is a surface processing apparatus to perform surface processing of the template 10 according to the embodiment recited above.

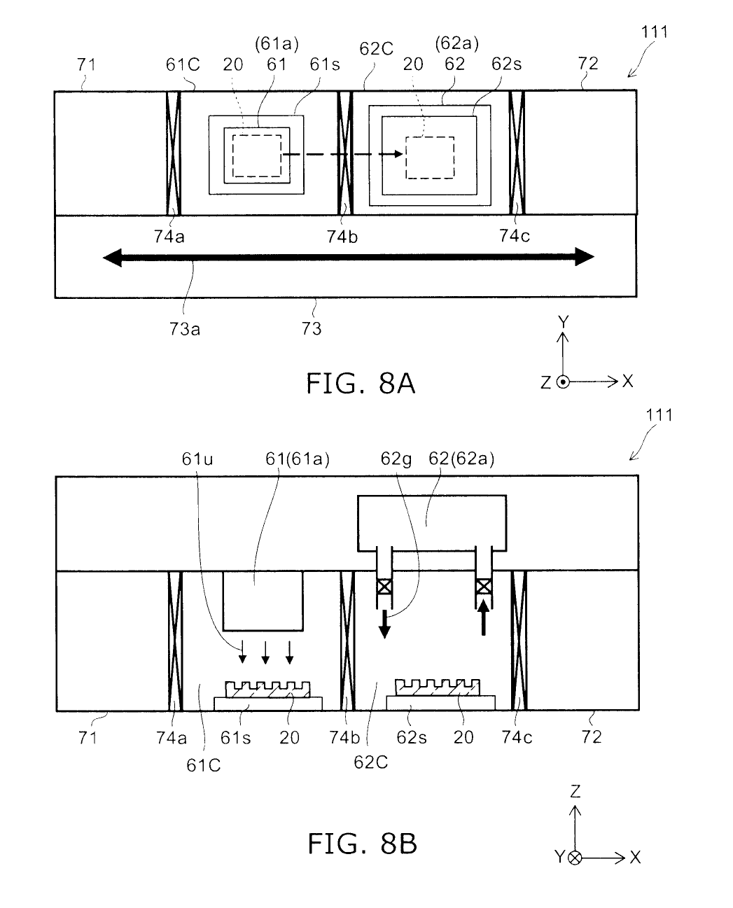

FIG. 8A and FIG. 8B are schematic views illustrating the surface processing apparatus of the template according to the third embodiment.

FIG. 8A is a plan view; and FIG. 8B is a side view.

As illustrated in FIG. 8A and FIG. 8B, the surface processing apparatus 111 according to this embodiment includes a first processing unit 61 and a second processing unit 62.

The first processing unit 61 forms a hydroxide group in the major surface 20a of the base member 20 (that is, the template 10, which is abbreviated hereinbelow). In other words, as illustrated in FIG. 7A, for example, a silanol group is formed in the major surface 20a of the base member 20. The base member 20 has the major surface 20a in which the unevenness 21 is provided and is transmissive with respect to the light 35 used to cure the photocurable resin liquid 30. Here, the photocurable resin liquid 30 is taken to be a resin liquid in the state prior to using light to cure the photocurable resin liquid 30.

The second processing unit 62 forms the surface layer 25 to cover the unevenness 21 of the major surface 20a that has the hydroxide group formed using the first processing unit 61. The contact angle between the surface layer 25 and the photocurable resin liquid 30 is not more than 30 degrees. In other words, the second processing unit 62 implements the reaction described in regard to FIG. 7B to FIG. 7E.

The unevenness pattern 11 that reflects the configuration of the unevenness 21 is formed using the surface layer 25 that is formed using the second processing unit 62.

In this example, a light irradiation unit 61a, which irradiates an ultraviolet ray 61u onto the base member 20, is used as the first processing unit 61. A source-material gas supply unit 62a, which supplies a source-material gas 62g used to form the surface layer 25 toward the base member 20, is used as the second processing unit 62.

The surface processing apparatus 111 of this specific example further includes a first chamber 61C, a second chamber 62C, a receiving unit 71, a dispatching unit 72, and a transfer unit 73.

The first processing unit 61 is disposed in the interior of the first chamber 61C. A first holding unit 61s is provided in the interior of the first chamber 61C. The base member 20 is placed on the first holding unit 61s. The first processing unit 61 is disposed above the base member 20.

The second chamber 62C communicates with the source-material gas supply unit 62a of the second processing unit 62. A second holding unit 62s is provided in the second chamber 62C. The base member 20 is placed on the second holding unit 62s. An opening is provided above the base member 20 to supply the source-material gas 62g from the second processing unit 62.

The base member 20 prior to processing is set at the prescribed position in the receiving unit 71. The processed base member 20 (the template 10) is dispatched from the dispatching unit 72. The transfer unit 73 has a transfer arm 73a to transfer the base member 20. The transfer arm 73a can move the base member 20 between, for example, the receiving unit 71, the first chamber 61C, the second chamber 62C, and the dispatching unit 72. A first shutter 74a is provided between the receiving unit 71 and the first chamber 61C. A second shutter 74b is provided between the first chamber 61C and the second chamber 62C; and a third shutter 74c is provided between the second chamber 62C and the dispatching unit 72.

The base member 20 moves between the receiving unit 71, the first chamber 61C, the second chamber 62C, and the dispatching unit 72 via the shutters recited above.

For example, the base member 20 is set by the transfer arm 73a from the receiving unit 71 to the first holding unit 61s of the first chamber 61C.

The ultraviolet ray 61u is irradiated from the first processing unit 61 (the light irradiation unit 61a) of the first chamber 61C toward the base member 20. The wavelength of the ultraviolet ray 61u is, for example, 172 nm. A hydroxide group is formed in the major surface 20a of the base member 20 by the ultraviolet ray 61u.

Namely, the oxygen inside the atmosphere reacts to produce ozone when the ultraviolet ray 61u is irradiated onto the major surface 20a of the base member 20; and oxygen radicals having a strong oxidizing capability are produced. As a result, for example, organic substances existing on the major surface 20a of the base member 20 are removed; and the surface of the base member 20 is cleaned. Then, the hydroxide group is formed in the major surface 20a of the cleaned base member 20.

As described in regard to FIG. 7A, in the case where quartz is used as the base member 20, a silanol group (Si-OH) is formed as the hydroxide group.

Thus, the amount of the hydroxide group of the major surface 20a of the base member 20 increases due to the processing by the first processing unit 61. The first processing unit 61 cleans, for example, the major surface 20a.

The base member 20 for which the processing in the first processing unit 61 has ended is transferred from the first chamber 61C to the second chamber 62C by the transfer arm 73a. The base member 20 is set in the second holding unit 62s.

The second processing unit 62 (and, in this example, the source-material gas supply unit 62a) supplies a compound into the second chamber 62C to form the surface layer 25. The supplied compound is, for example, a compound represented by Rₙ—Si—X₄₋ₙ (where n is an integer not less than 1 and not more than 3, X is an alkoxy group, an acetoxy group, or a halogen atom, and R is an alkyl group). Here, the supplied compound also may be, for example, a compound represented by R₃—Si—NH.Si.R′₃ (where R′ is an organic functional group and R is an organic functional group) or a compound represented by R₃—Si—NR′₂ (where R′ is an organic functional group and R is an organic functional group).

Thereby, the reactions described in regard to FIG. 7B to FIG. 7E are performed; and the surface layer 25 is formed.

In other words, as illustrated in FIG. 7B, for example, the functional group X of Rₙ—Si—X₄₋ₙ of the source-material gas 62g produces a silanol group by a hydrolysis reaction with the moisture of the atmosphere.

As illustrated in FIG. 7C and FIG. 7D, the silanol group formed in the major surface 20a of the base member 20 reacts with the silanol group of the source-material gas 62g; and a portion of the compound of the source-material gas 62g bonds to the base member 20.

Then, as illustrated in FIG. 7E, the silanol groups of a portion of the multiple compounds bonded to the base member 20 undergo a dehydrating condensation reaction with each other. Thereby, the surface layer 25 is formed. The contact angle between the surface layer 25 thus formed and the photocurable resin liquid 30 is not more than 30 degrees. Thereby, the template 10 is constructed.

The template 10 obtained when the processing ends is dispatched from the dispatching unit 72.

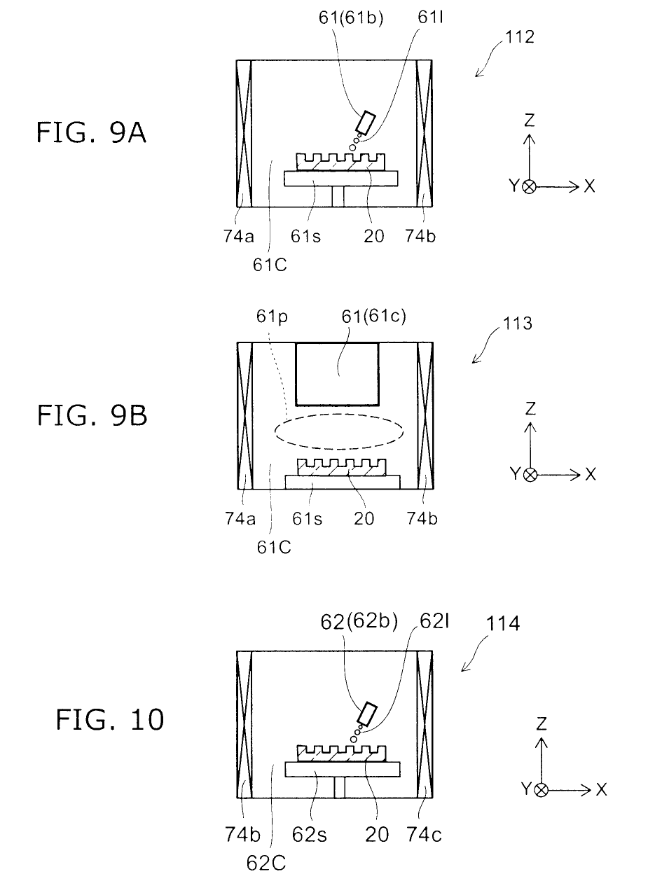

FIG. 9A and FIG. 9B are schematic side views illustrating other surface processing apparatuses of the template according to the third embodiment.

These drawings illustrate other examples of the first processing unit 61.

In a surface processing apparatus 112 according to this embodiment as illustrated in FIG. 9A, a chemical liquid supply unit 61b is used as the first processing unit 61. The chemical liquid supply unit 61b supplies a chemical liquid 611 for forming the hydroxide group toward the major surface 20a. For example, methods such as spin coating, spray coating, and the like are used to supply the chemical liquid 611. Here, the base member 20 may be immersed in the chemical liquid 611.

In a surface processing apparatus 113 according to this embodiment as illustrated in FIG. 9B, a plasma processing unit 61c is used as the first processing unit 61. The plasma processing unit 61c generates plasma 61p. The major surface 20a of the base member 20 (i.e., the template 10) is processed by the plasma 61p. Thereby, a hydroxide group is formed.

Thus, any configuration that forms the hydroxide group can be applied in the first processing unit 61.

FIG. 10 is a schematic side view illustrating another surface processing apparatus of the template according to the third embodiment.

This drawing illustrates another example of the second processing unit 62.

In the surface processing apparatus 114 according to this embodiment as illustrated in FIG. 10, a source material liquid supply unit 62b is used as the second processing unit 62. The source material liquid supply unit 62b supplies a source material liquid 621 toward the base member 20 (i.e., the template 10) to form the surface layer 25. The supplying of the source material liquid 621 may include, for example, a method such as spin coating, spray coating, and the like. The base member 20 may be immersed in the source material liquid 621. Thereby, the surface layer 25 is formed. If necessary, a unit configured to supply a rinsing fluid, a unit configured to supply a cleaning liquid, and the like may be further provided.

Thus, any configuration that is capable of supplying at least one selected from the source-material gas 62g and the source material liquid 621 used to form the surface layer 25 can be applied to the second processing unit 62.

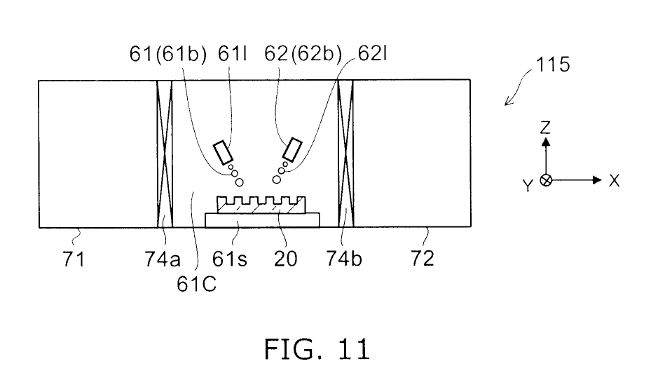

FIG. 11 is a schematic side view illustrating another surface processing apparatus of the template according to the third embodiment.

As illustrated in FIG. 11, the second chamber 62C is omitted from the surface processing apparatus 115 according to this embodiment. The first processing unit 61 (in this example, the chemical liquid supply unit 61b) and the second processing unit 62 (in this example, the source material liquid supply unit 62b) are provided in the first chamber 61C.

Thus, various modifications are possible in the surface processing method of a template according to the embodiment.

In this embodiment, the formation of the surface layer 25 may be performed at a reduced pressure.

### Fourth Embodiment

This embodiment is a pattern formation method using the template 10 according to the first embodiment. As described in regard to FIG. 1C to FIG. 1E, in this surface processing method, the photocurable resin liquid 30 is filled into the recess 11d of the unevenness pattern 11 of the template 10 (step S120). Then, the photocurable resin liquid 30 is cured by irradiating the light 35 onto the photocurable resin liquid 30 in the state of the photocurable resin liquid 30 being filled into the recess 11d (step S130); and the resin 31 is formed in a configuration that reflects the unevenness pattern 11. Then, the template 10 and the resin 31 are released from each other (step S140). In this surface processing method, the occurrence of defects in the releasing of step S140 can be suppressed while shortening the fill time of step S120 because the contact angle A between the surface layer 25 of the template 10 and the photocurable resin liquid 30 is not more than 30 degrees. According to this surface processing method, a pattern formation method having high productivity can be realized.

According to the embodiments, a template, a surface processing method of the template, a surface processing apparatus of a template, and a pattern formation method are provided to realize a pattern formation method having high productivity.

Hereinabove, several embodiments of the invention are described with reference to specific examples. However, the embodiments of the invention are not limited to these specific examples. For example, one skilled in the art may similarly practice the invention by appropriately selecting specific configurations of components included in templates such as base members, surface layers, and the like from known art; and such practice is included in the scope of the invention to the extent that similar effects are obtained.

Moreover, all templates, surface processing methods of templates, surface processing apparatuses of a template, and pattern formation methods practicable by an appropriate design modification by one skilled in the art based on the templates, the surface processing methods of templates, the surface processing apparatuses of a template, and the pattern formation methods described above as embodiments of the invention also are within the scope of the invention to the extent that the spirit of the invention is included.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A template including a transfer surface having an unevenness pattern, the template being configured to form a configuration in a surface of a resin to reflect the unevenness pattern, the resin being formed by filling a photocurable resin liquid into a recess of the unevenness pattern in a state prior to using light to cure the photocurable resin liquid and by using the light to cure the photocurable resin liquid, the template comprising:
a base member including a major surface having an unevenness, the base member being transmissive with respect to the light used to cure the photocurable resin liquid; and
a surface layer covering the unevenness of the base member, the surface layer being used to form the unevenness pattern to reflect a configuration of the unevenness,
a contact angle between the surface layer and the photocurable resin liquid in the state prior to using the light to cure the photocurable resin liquid being not more than 30 degrees.

2. The template according to claim 1, wherein a work of adhesion of the surface layer to the resin is less than 80 millijoules/square meter.

3. The template according to claim 1, wherein the surface layer includes a layer formed by bonding a compound to the base member by a condensation reaction of the compound, the compound being represented by Rₙ—Si—X₄₋ₙ (where n is an integer not less than 1 and not more than 3, X is a functional group, and R is an organic functional group).

4. The template according to claim 3, wherein X is an alkoxy group, an acetoxy group, or a halogen atom.

5. The template according to claim 1, wherein the surface layer includes a layer formed by bonding a compound to the base member, the compound being represented by R₃—Si—NH.Si.R′₃ (where R′ is an organic functional group and R is an organic functional group).

6. The template according to claim 1, wherein the surface layer includes a layer formed by bonding a compound to the base member, the compound being represented by R₃—Si—NR′₂ (where R′ is an organic functional group and R is an organic functional group).

7. The template according to claim 5, wherein R′ is an alkyl group.

8. The template according to claim 3, wherein R is an alkyl group represented by CH₃(CH₂)ₖ (where k is an integer not less than 0).

9. The template according to claim 3, wherein R is a methyl group.

10. A surface processing method of a template, the template including a transfer surface having an unevenness pattern, the template being configured to form a configuration in a surface of a resin to reflect the unevenness pattern, the resin being formed by filling a photocurable resin liquid into a recess of the unevenness pattern in a state prior to using light to cure the photocurable resin liquid and by using the light to cure the photocurable resin liquid, the surface processing method comprising
forming the unevenness pattern to reflect a configuration of an unevenness provided in a major surface of a base member by forming a surface layer to cover the unevenness, the base member being transmissive with respect to the light used to cure the photocurable resin liquid, a contact angle between the surface layer and the photocurable resin liquid in the state prior to using the light to cure the photocurable resin liquid being not more than 30 degrees.

11. The method according to claim 10, wherein the forming of the surface layer includes performing vapor deposition of the surface layer.

12. The method according to claim 10, wherein a work of adhesion of the surface layer to the resin is less than 80 millijoules/square meter.

13. The method according to claim 10, wherein the surface layer includes a layer formed by bonding a compound to the base member by a condensation reaction of the compound, the compound being represented by Rₙ—Si—X₄₋ₙ (where n is an integer not less than 1 and not more than 3, X is a functional group, and R is an organic functional group).

14. The method according to claim 13, wherein X is an alkoxy group, an acetoxy group, or a halogen atom.

15. The method according to claim 10, wherein the surface layer includes a layer formed by bonding a compound to the base member, the compound being represented by R₃—Si—NH.Si.R′₃ (where R′ is an organic functional group and R is an organic functional group).

16. The method according to claim 10, wherein the surface layer includes a layer formed by bonding a compound to the base member, the compound being represented by R₃—Si—NR′₂ (where R′ is an organic functional group and R is an organic functional group).

17. The method according to claim 15, wherein R′ is an alkyl group.

18. The method according to claim 13, wherein R is a methyl group or an alkyl group represented by CH₃(CH₂)ₖ (where k is an integer not less than 0).

19. A surface processing apparatus of a template, the template including a transfer surface having an unevenness pattern, the template being configured to form a configuration in a surface of a resin to reflect the unevenness pattern, the resin being formed by filling a photocurable resin liquid into a recess of the unevenness pattern in a state prior to using light to cure the photocurable resin liquid and by using the light to cure the photocurable resin liquid, the apparatus comprising:
a first processing unit configured to form a hydroxide group in a major surface of a base member, an unevenness being provided in the major surface of the base member, the base member being transmissive with respect to the light used to cure the photocurable resin liquid; and
a second processing unit configured to form a surface layer to cover the unevenness of the major surface having the hydroxide group formed by the first processing unit, a contact angle between the surface layer and the photocurable resin liquid in the state prior to using the light to cure the photocurable resin liquid being not more than 30 degrees.

20. A pattern formation method, comprising:
filling a photocurable resin liquid into a recess of an unevenness pattern of a template, the template including a transfer surface having the unevenness pattern, the template being configured to form a configuration in a surface of a resin to reflect the unevenness pattern, the resin being formed by filling the photocurable resin liquid into the recess of the unevenness pattern in a state prior to using light to cure the photocurable resin liquid and by using the light to cure the photocurable resin liquid, the template including a base member and a surface layer, the base member including a major surface having an unevenness, the base member being transmissive with respect to the light used to cure the photocurable resin liquid, the surface layer being configured to cover the unevenness of the base member and being used to form the unevenness pattern to reflect a configuration of the unevenness, a contact angle between the surface layer and the photocurable resin liquid in the state prior to using the light to cure the photocurable resin liquid being not more than 30 degrees;
forming the resin having the configuration reflecting the unevenness pattern by curing the photocurable resin liquid in the state of the photocurable resin liquid being filled into the recess by irradiating the light onto the photocurable resin liquid in the state prior to using the light to cure the photocurable resin liquid; and
releasing the template and the resin from each other.
